(19) United States
(12) Patent Application Publication
(10) Pub. No.: US 2007/0186708 A1
(43) Pub. Date: Aug. 16, 2007

(54) Recirculating element for ball screw

(75) Inventors: Chi-Meng Liao, Taichung (TW); Chia-Min Liu, Taichung (TW)

Correspondence Address: HDSL, 4331 STEVENS BATTLE LANE, FAIRFAX, VA, 22033, US

(73) Assignee: Hiwin Technologies Corp.

(21) Appl. No.: 11/354,842

(22) Filed: Feb. 16, 2006

(51) Int. Cl. F16H 25/22

(52) U.S. Cl. 74/424.86

(57) ABSTRACT

The recirculating element having a turning track corresponding to helical track of a ball screw and corresponding to returning hole of nut. And the turning track comprises a tangential direction changing position and a screw thread departing position being adjacent to an entrance of the turning track. And the entrance of the turning track has an upper wall surface and a lower wall face, which form a first inclined angle and a second inclined angle with the horizontal direction respectively. The first angle of the upper wall surface is smaller or equal to a minimum lead angle of the ball screw and the second inclined angle of the lower wall surface is smaller or equal to a maximum lead angle of the ball screw. So it is suitable for ball screws with different leads.

### BACKGROUND OF THE INVENTION

1. Field of the invention The present invention relates to a recirculating element for ball screws, and more particularly, to a recirculating element for ball screws comprising various geometric shapes for an entrance of the turning track of the recirculating element, thus suitable for ball screws with different lead.

2. Description of the Prior Art

Generally, various recirculating element of ball screws can be classified as external recirculation type, internal recirculation type, and end cap type, wherein only the end cap type is disposed at the end of the nut, as shown in FIG. 1 and 2. The prior art recirculating element 4 is correspondingly disposed at the end plane of nut 3, a turning track 41 of recirculating element 4 is formed correspondingly to a returning hole 31 of nut 3, an entrance 42 of turning track 41 connecting to the helical track of the ball screw (not shown in figure) for rolling element of ball screw to be able to turn and circulate to finish the recirculation movement.

Please refer to FIG. 3, considering ball screws with different leads, the major difference of prior art ball screws is that when the rolling element departs from the helical track of the ball screw, the inclined angle (which is lead angle α) between the tangential direction of the track of the ball screw and the plane of the cross section of ball screw is different. For example, when the outer diameter is 20 mm and the lead (the spacing of screw thread) is 5 mm, the lead angle is 4.54 degree; when the lead is 10 mm, the lead angle is 9.04 degree; when the lead is 20 mm, the lead angle is 17.65 degree; when the lead is 40 mm, the lead angle is 32.48 degree. If ball screws having different leads are to use the same recirculating element, when the rolling element departs from the helical track and rolls into turning track 41, it is difficult for the rolling element to depart from the track and adjust its tangential angle at the same time, therefore, it is likely that the smooth operation of the machine will be affected.

Hence, entrance 42 of turning track 41 of recirculating element 4 should be configured according to lead angle α, and each ball screw with different lead should use a recirculating element 4 having a corresponding lead angle respectively. Since each different recirculating element 4 should be manufactured separately, the cost for manufacturing and maintaining a new mold tends to increase. Furthermore, since manufacturers have to reserve stocks for different recirculating elements, the inventory holding cost will also increase, and it is possible that recirculating elements with incorrect lead angle could be deployed in assembling the ball screws, virtually introducing unreliability in assembling the products.

In other words, the prior art ball screw using specific recirculating element with certain lead is not applicable to the development trend towards sharing of common elements in manufacturing different ball screws, and it is possible that the complexity of inventory maintenance and assembly process will rise, thereby causing the manufacturing cost to increase.

In view of the above-described deficiencies of traditional recirculating elements, after years of constant effort in research, the inventor of this invention has consequently developed and proposed a recirculating element for ball screws in the present invention.

### SUMMARY OF THE INVENTION

It is an object of the present invention to provide ball screws with a recirculating element, which provides a wider range of entrance of the turning track for rolling element to depart from the track and to change it position in the tangential direction.

It is another object of the present invention to provide ball screws with a recirculating element, which is suitable for different leads to enhance economic benefits.

It is another object of the present invention to provide a recirculating element, which can change the tangential path of the rolling element.

It is still another object of the present invention to provide a recirculating element, which can meet requirements of minimum lead angle and maximum lead angle for ball screws.

The present invention discloses a recirculating element for ball screw, the recirculating element being disposed at an end plane of the nut of the ball screw, the recirculating element having a turning track formed thereon, a first end of the turning track corresponding to a helical track of the ball screw and a second end of the turning track corresponding to a returning hole of the nut respectively.

The above-mentioned turning track of the recirculating element comprises an entrance corresponding to a helical track of ball screw, wherein the entrance has a screw thread departing position comprising an upper wall surface and a lower wall surface, both with outwardly inclined angles, meanwhile, the upper wall surface is not parallel to the lower wall surface, the upper wall surface forming an inclined angle β with the horizontal direction, and said lower wall surface forming an inclined angle γ with the horizontal direction.

### BRIEF DESCRIPTION OF THE DRAWINGS

The drawings disclose an illustrative embodiment of the present invention which serves to exemplify the various advantages and objects hereof, and are as follows:
FIG. 1 illustrates an exploded view of a nut body of a prior art ball screws;
FIG. 2 illustrates a 3D view of a prior art recirculating element;
FIG. 3 illustrates a planar view of a prior art recirculating element;
FIG. 4 illustrates a 3D view of the composition of the recirculating element in the present invention;
FIG. 5 illustrates a side view showing the corresponding relationship of the entrance of the turning track of the recirculating element;
FIG. 6 illustrates a side view showing the recirculating element in real recirculation operation; and
FIG. 7 illustrates a top view of the entrance of the turning track of the recirculating element.

### DETAILED DESCRIPTION OF THE PREFERRED EMBODIMENT

Please refer to FIG. 4, the present invention provides ball screws with a recirculating element 1, mainly comprises: recirculating element 1 suitable for ball screws with different leads, a turning track 11 corresponding to the track of ball screw formed on recirculating element 1, turning track 11 comprising a tangential direction changing position 111 and a screw thread departing position 112, wherein screw thread departing position 112 is adjacent to an entrance 12, and entrance 12 gradually takes the shape of a varying cone from an end plane 15 of recirculating element 1 along tangential direction changing position 111, and then entrance 12 forming a upper wall surface 13 and a lower wall surface 14, each forming a inclined angle with the horizontal direction respectively.

The inclined angle β of upper wall surface 13 is larger or equal to the minimum lead angle αₘᵢₙ, and an end of the upper wall surface 13 of recirculating element 1 is connected to screw thread departing position 112 of screw having the minimum lead angle αₘᵢₙ, the inclined angle γ of lower wall surface 14 is smaller or equal to the maximum lead angle αₘₐₓ of ball screw, similarly, an end of the lower wall surface 14 of recirculating element 1 is connected to screw thread departing position 112 of screw having the maximum lead angle α max, so when the rolling element departs from the screw track and before enters the position where the tangential direction changes, that is, before the rolling element enters tangential direction changing position 111, the recirculating element can keep the rolling element running smoothly in order to cooperate with ball screws with different leads and to simplify the specifications in manufacturing recirculating element 1.

Recirculating element 1 corresponds to an adjacent inserted trench disposed at an inside edge of the nut, please refer back to FIG. 4, wherein recirculating element 1 has turning track 11 formed thereon, with one end of turning track 11 correspondingly connecting to the track of the ball screw and the other end connecting to a returning hole of the nut, furthermore, turning track 11 corresponding to the track of ball screw and forming a lead angle with respect to the horizontal direction for the rolling element to use turning track 11 to turn inside recirculating element to finish the recirculation movement

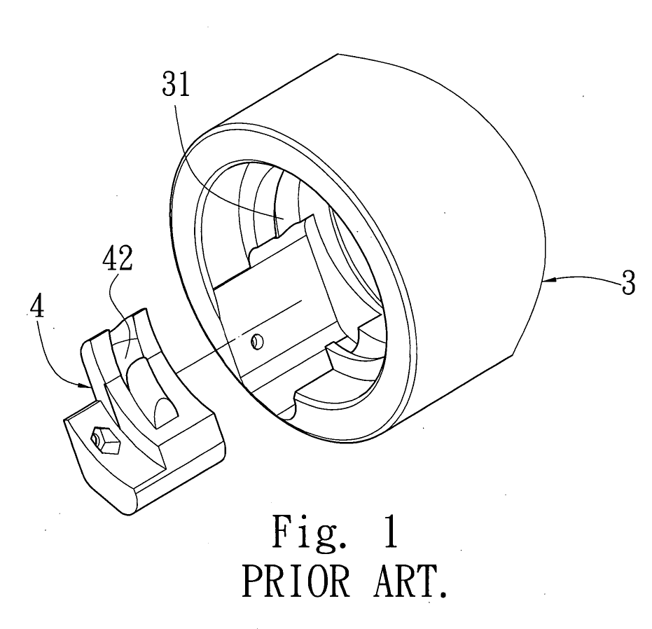

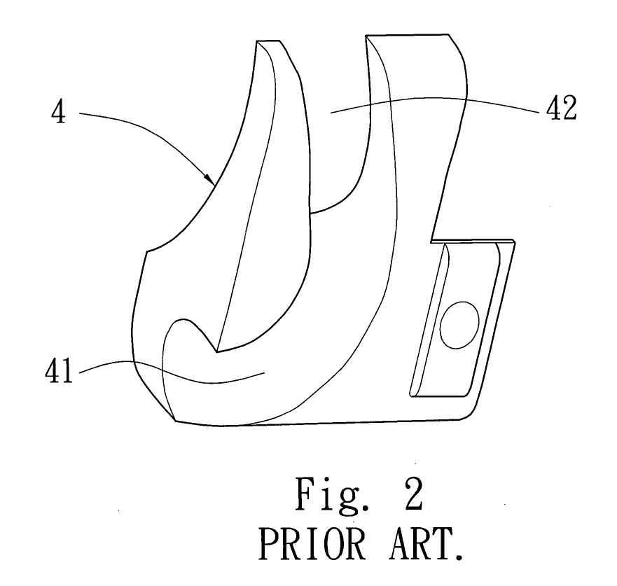

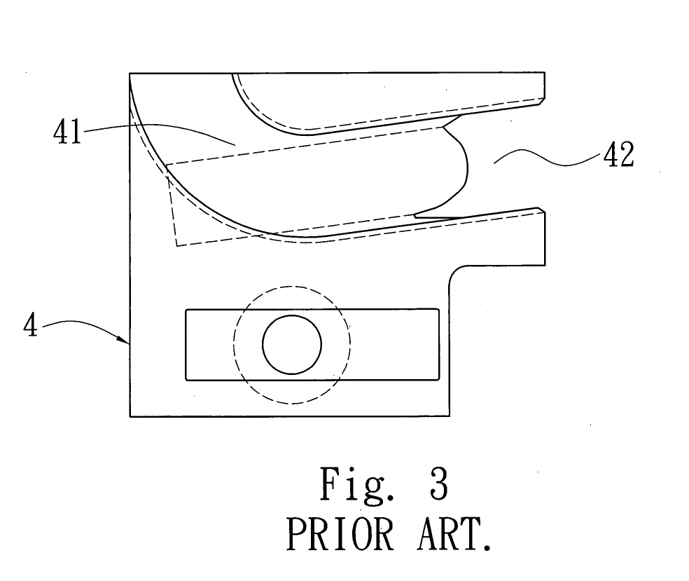

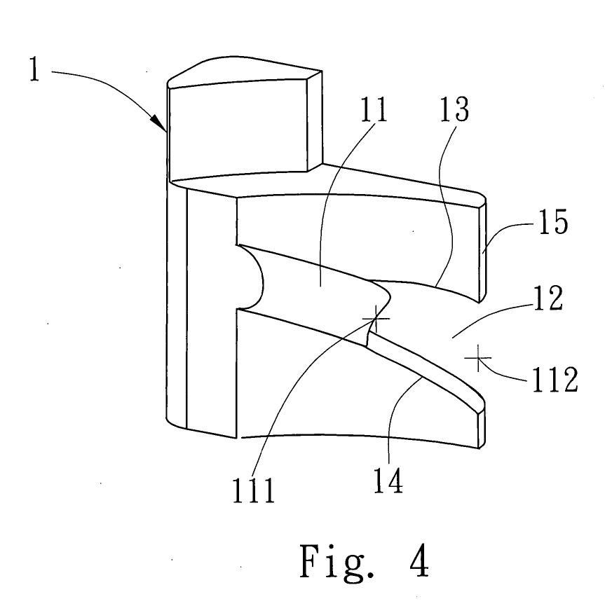

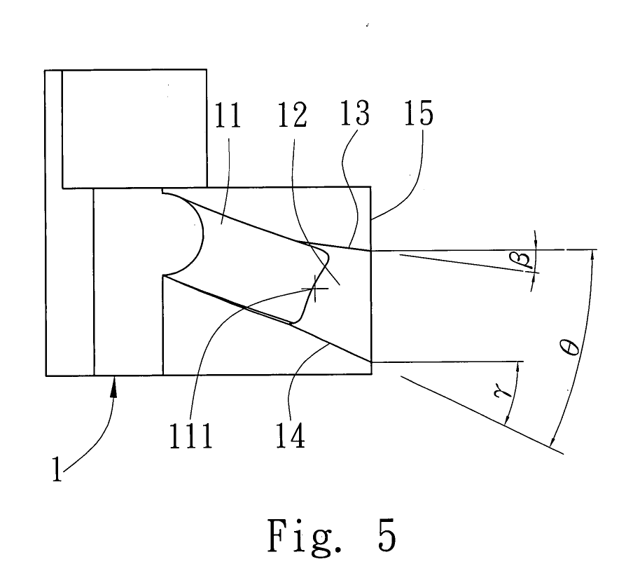

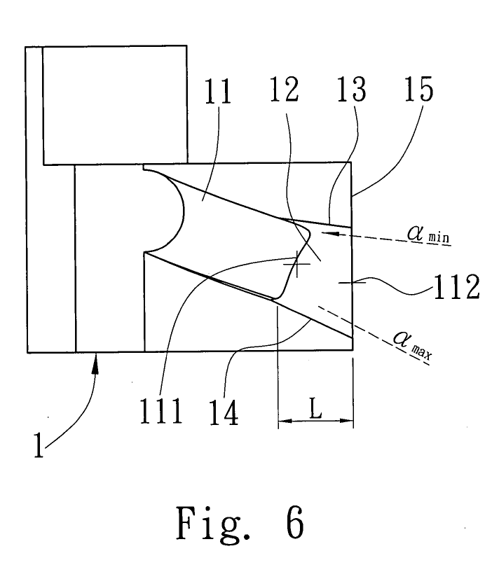

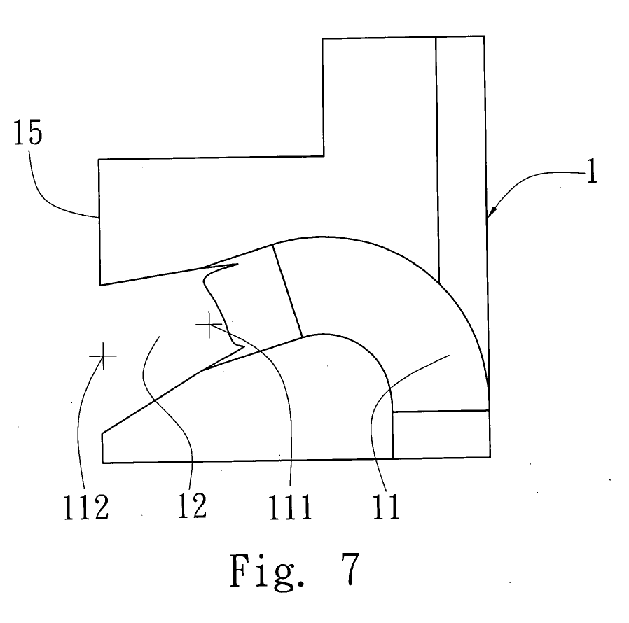

As to the detailed description of the present invention, please refer to FIG. 4 to 7, turning track 11 of recirculating element 1 comprises entrance 12 corresponding to the helical track of ball screw, and turning track 11 is implemented by tangential direction changing position 111 corresponding to the returning hole of the nut, and also corresponding to the track of the ball screw, wherein entrance 12 comprises outwardly inclined upper wall surface 13 and lower wall surface 14, and upper wall surface 13 and lower wall surface 14 together forming a angle θ on a projected plane, as shown in FIG. 5.

As with entrance 12, upper wall surface 13 is not parallel to lower wall surface 14, and upper wall surface 13 forming an inclined angle β with the horizontal direction, while lower wall surface 14 forming an inclined angle γ with the horizontal direction, wherein inclined angle β of upper wall surface 13 is larger than αₘᵢₙ, while αₘᵢₙ is the smallest lead angle for recirculating element 1. inclined angle γ of lower wall surface 14 is smaller than αₘₐₓ, while αₘₐₓ is the largest lead angle for recirculating element 1;
wherein a length L of screw thread departing position 112 of entrance 12 of recirculating element is:
   L≦D_{ball}
wherein
L is a horizontal distance of end plane 15 of entrance 12 of recirculating element 1 to an intersection point of lower wall surface 14 and turning track 11; and
D_{ball} is a diameter of a rolling element.

Since turning track 11 is a little bit larger than the diameter of the rolling element, therefore the rolling element in turning track 11 is not restrained. However, entrance 12 further extends the gap, when the gap becomes too large, it will affect the movement of the ball screw. Hence, as the length L of entrance 12 set to be L<D ball, it is viable to maintain screw thread departing position 112 and tangential direction changing position 111 and also to avoid the movement of the ball screw form being affected by large gaps. Therefore, the present invention provides ball screws with recirculating element 1 suitable for different lead specifications.

In the present invention, please refer to FIGS. 5 and 6 for embodiment of recirculating element 1. The present invention implements the outermost size of entrance 12 adjacent to screw thread departing position 112 to be a little bit larger than the track of the ball screw, thereby allowing a buffer space for the rolling element when the rolling element departs from the track of ball screw, in the meantime, entrance 12 of turning track is implemented to be a cone shape which is inclined outwardly for the rolling element to depart from screw thread departing position 112 and then to move along the space provided by upper wall surface or lower wall surface before entering tangential direction changing position 111 of turning track 11 of recirculating element 1 and changing its tangential direction, and then the rolling element entering turning track 11 through tangential direction changing position 111 then moving on to the returning hole of the nut. Hence, recirculating element 1 disclosed in the present invention comprises outwardly inclined turning track entrance 12 suitable for ball screw with different lead angles to extends its applicability, thereby facilitating smooth operation of ball screws and reducing molds needed to implement ball screws and further reducing the manufacturing costs and enhancing yield rate.

The present invention provides a recirculating element for ball screws, while compared with other traditional recirculating elements, is advantageous in:

1. Simplified specifications for recirculating elements: The single recirculating element disclosed in the present invention is suitable for ball screws with different leads, therefore, it only takes a simple classification process to avoid mistakenly using wrong recirculating elements in assembling ball screws.

2. Better cost effectiveness: Besides, the one-body recirculating element disclosed herein is manufactured by single injection molding process without additional assembly works, in the meantime, fewer specifications for recirculating elements can relatively reduce the number of molds, as to the manufacture, maintenance and storage of molds, the recirculating element disclosed herein can effectively reduce cost and to enhance economic benefits.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A recirculating element for ball screws, said recirculating element corresponding to an adjacent inserted trench disposed at an inside edge of a nut, said recirculating element having a turning track formed thereon, a first end of said turning track corresponding to a helical track of a ball screw and a second end of said turning track corresponding to a returning hole of said nut respectively;
said turning track having an entrance corresponding to said helical track, said entrance having a screw thread departing position comprising an upper wall surface and a lower wall surface, each with an inclined angle, wherein said upper wall surface is not parallel to said lower wall surface, said upper wall surface forming an. inclined angle β with the horizontal direction, and said lower wall surface forming an inclined angle γ with the horizontal direction, thereby implementing said recirculating element suitable for ball screws with different leads.

2. The recirculating element for ball screws of claim 1, wherein said inclined angle β of said upper wall surface is larger or equal to αₘᵢₙ, while αₘᵢₙ is the smallest lead angle for said recirculating element.

3. The recirculating element for ball screws of claim 1, wherein said inclined angle γ of said lower wall surface is smaller or equal to αₘₐₓ, while αₘₐₓ is the largest lead angle for said recirculating element.

4. The recirculating element for ball screws of claim 1, wherein said upper wall surface and said lower wall surface forming an angle θ with each other on a projected plane.

5. The recirculating element for ball screws of claim 1, wherein a length of said screw thread departing position of said recirculating element is:
L≦D_{ball}
wherein
L is a horizontal distance of said entrance of said recirculating element to an intersection point of said lower wall surface and said turning track; and
D_{ball} is a diameter of a rolling element.

6. The recirculating element for ball screws of claim 1, wherein said turning track has a first end of said turning track corresponding to a helical track connecting of a ball screw and a second end of said turning track corresponding to a returning hole of said nut respectively.

7. The recirculating element for ball screws of claim 1, wherein said entrance of turning track having an inclined angle which is outwardly inclined.

8. The recirculating element for ball screws of claim 1, wherein an end of said inclined angle of said recirculating element can be connected to said screw thread departing position of said screw having a minimum lead angle.

9. The recirculating element for ball screws of claim 1, wherein an end of said inclined angle of said recirculating element can be connected to said screw thread departing position of said screw having a maximum lead angle.
